(19) United States
(12) Patent Application Publication
(10) Pub. No.: US 2005/0089710 A1
(43) Pub. Date: Apr. 28, 2005

(54) Powder-sintered multi-layer tool part and manufacturing method thereof

(75) Inventors: Keita Hirai, Saitama-ken (JP); Akira Hirai, Saitama-ken (JP)

Correspondence Address: EDWARDS & ANGELL, LLP, P.O. BOX 55874, BOSTON, MA, 02205, US

(73) Assignee: Akira, HIRAI

(21) Appl. No.: 10/739,452

(22) Filed: Dec. 17, 2003

(30) Foreign Application Priority Data
Oct. 27, 2003 (KR) 10-2003-75076

(51) Int. Cl. B32B 15/01; B32B 15/04

(52) U.S. Cl. 428/627; 428/642

(57) ABSTRACT

A powder-sintered multi-layer tool part and a manufacturing method thereof adapted to manufacture a tool part in multi-layer form by integrally sintering and forming a super hardness metal layer with a soft metal layer having a high toughness via a powder-sintering method, thereby making it possible for the abrasion resistance characteristic of the super high hardness metal layer to be compatible with the mountability characteristic of the soft metal layer. The powder-sintered multi-layer tool part comprises: a first super hardness metal layer containing a vanadium carbide powder 20-90% by weight and a pure titanium powder or a titanium alloy powder 10-80% by weight, the titanium alloy powder containing a titanium component 60% by weight or more, thereby forming an aggregate mixed powder of 100% by weight and having a predetermined high hardness; and a second soft metal layer having a mounting part and containing said pure titanium powder or said titanium alloy powder 100% by weight, and wherein the metal powders of the first super hardness metal layer and the second soft metal layer are integrally pressed and sintered under a predetermined temperature.

### FIELD OF THE INVENTION

The present invention relates to a powder-sintered multi-layer tool part used by being attached to industrial tools and a manufacturing method thereof and, more particularly, to a tool part formed in a multi-layer form by a powder-sintering method so as to have a high abrasion resistance and good mountability characteristics.

### BACKGROUND OF THE INVENTION

Tool parts used by being attached to industrial tools such as cutters, scissor blades, circular rotating blades, cam plates and the like call for a high abrasion resistance because these tool parts are frequently contacted with and frayed against other members to thereby be easily abraded.

There is an advantage in conventional carbon steel-base tool parts manufactured by the conventional quench hardening method in that they can be easily attached to industrial tools by welding or screw coupling, but there is a disadvantage in that the upper limit of Rockwell Hardness Number thereof is fairly low, that is, HRA 85 or less, such that they can be easily abraded.

There is another disadvantage in that, although hardness may be increased when tool parts are made of ceramic material to expect an improvement of abrasion resistance, crushing can easily occur due to a lack of strength when tool parts are made of thin shapes. There is still another disadvantage in that it is difficult to attach a ceramic material tool parts to industrial tools by way of a welding or screw coupling method, such that a costly attaching means should be considered for attaching a ceramic material tool parts to industrial tools.

Meanwhile, there is still further disadvantage in that, although industrial tools may be manufactured by using a high hardness alloy such as hybrid alloy made of tungsten carbide and cobalt or the like, this material is heavy in specific gravity thereof. There is still a further disadvantage in that a specific processing should be carried out for forming holes on the tool parts due to the high hardness level, resulting in a high manufacturing cost and making it impossible to install the tool parts by welding.

There is still a further disadvantage in that industrial tools made of such conventional materials as mentioned above are made as a single body, causing the abrasion resistance characteristic to be incompatible with the mountability characteristic in the tools.

### SUMMARY OF THE INVENTION

The present invention provides a powder-sintered multi-layer tool part and a manufacturing method thereof adapted to manufacture a tool part in multi-layer form by integrally sintering and forming a super hardness metal layer with a soft metal layer having a high toughness via a powder-sintering method, thereby causing the abrasion resistance characteristic of the super high hardness metal layer to be compatible with the mountability characteristic of the soft metal layer.

In accordance with one embodiment of the present invention, there is provided a powder-sintered multi-layer tool part comprising: a first super hardness metal layer containing a vanadium carbide powder 20-90% by weight and a pure titanium powder or a titanium alloy powder 10-80% by weight, the titanium alloy powder containing a titanium component 60% by weight or more, thus forming an aggregate mixed powder of 100% by weight and having a predetermined high hardness; and a second soft metal layer having a mounting part and containing the pure titanium powder or titanium alloy powder 100% by weight, wherein the metal powders of the first super hardness metal layer and the second soft metal layer are integrally pressed and sintered under a predetermined temperature.

In accordance with another embodiment of the present invention, there is provided a powder-sintered multi-layer tool part manufacturing method comprising the steps of forming a first super hardness metal layer containing a vanadium carbide powder 20-90% by weight and a pure titanium powder or a titanium alloy powder 10-80% by weight, the titanium alloy powder containing a titanium component 60% by weight or more, thus forming an aggregate mixed powder of 100% by weight and having a predetermined high hardness; forming a second soft metal layer having a mounting part and containing the pure titanium powder or titanium alloy powder 100% by weight; and filling the metal powders of the first super hardness metal layer and the second soft metal layer in a mold for integral pressing and sintering same under a predetermined temperature.

### BRIEF DESCRIPTION OF THE DRAWINGS

For fuller understanding of the nature and objects of the present invention, reference should be made to the following detailed description taken in conjunction with the accompanying drawings in which:

FIG. 1 is a schematic perspective view of a cutter that is a powder-sintered multi-layer tool part according to an embodiment of the present invention;

FIG. 2 is a schematic perspective view of a scissor blade that is a powder-sintered multi-layer tool part according to an embodiment of the present invention;

FIG. 3 is a schematic perspective view of a cam plate that is a powder-sintered multi-layer tool part according to an embodiment of the present invention; and

FIG. 4 is a schematic perspective view of a circular rotary knife that is a powder-sintered multi-layer tool part according to an embodiment of the present invention.

### DETAILED DESCRIPTION OF THE PREFERRED EMBODIMENTS

The preferred embodiments of the present invention will now be described in detail with reference to the accompanying drawings. Throughout the drawings, like reference numerals and symbols are used for designation of like or equivalent parts or portions.

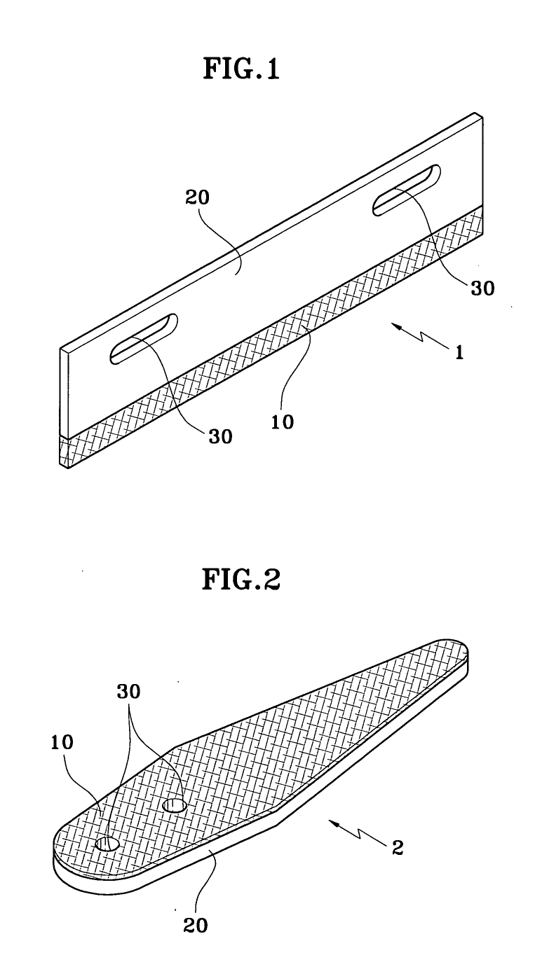

FIG. 1 illustrates a schematic view of a cutter 1 to be attached to industrial tools, as a tool part according to an embodiment of the present invention. The cutter 1 is comprised of a first super hardness metal layer 10, a second soft metal layer 20 integrally formed on the first super hardness metal layer 10 and mounting holes 30 formed at a mounting part of the second soft metal layer 20 for being secured to industrial tools.

The first super hardness metal layer 10 calls for a high hardness and a good abrasion resistance in order to prevent abrasion caused by contact and friction with other members, such that the first metal layer 10 is made of vanadium carbide powder as an improved abrasion resistant material in the present invention. In the embodiment of the present invention illustrated in FIG. 1, the first super hardness metal layer 10 contains a vanadium carbide powder 20-90% by weight and a pure titanium powder and a titanium alloy powder 10-80% by weight, the titanium alloy powder containing a titanium component 60% by weight or more, thus forming an aggregate mixed powder of 100% by weight. VC is referred to as vanadium carbide powder.

If the VC rate of the first super hardness metal layer 10 is 20% by weight or less, the metal layer is characterized by having a decrease in hardness level and an increase in toughness, thereby reducing the occurrence of abrasion. These characteristics are not good for the purpose of the present invention. Meanwhile, if VC is 90% by weight or more, its brittleness increases such that if a large load is applied to industrial tools, they are likely to crack or break.

If the VC rate of the first super hardness metal layer 10 is 90% by weight, the metal layer has a hardness value of approximately HRA 95 by Rockwell Hardness Number, and if the VC rate is 20% by weight, the metal layer 10 has a hardness value of approximately HRA 70 by Rockwell Hardness Number.

Meanwhile, both the first super hardness metal layer 10 and second soft metal layer 20 are made of the same titanium or titanium alloy (described later). The titanium powder contained in both layers 10 and 20 acts to strongly combine the two layers 10 and 20 when the two layers 10 and 20 are integrally sintered.

Pure titanium or titanium ally is adopted for the present invention as a material for the second soft metal layer 20 because it can be easily processed and welded and has a high toughness, thus facilitating the attachment of the tool part to industrial tools. The second soft metal layer 20 is comprised of a pure titanium or titanium alloy 100% by weight, the titanium alloy containing a titanium component of 60% by weight or more.

Although the titanium or titanium alloy is low in hardness compared with that of the VC, the former is soft, has high toughness and low specific gravity, and it is light compared to the carbon steel-base tool parts. Also, the formation of holes may easily be formed in titanium or titanium alloy for attaching the second soft metal layer to industrial tools. Furthermore, titanium or titanium alloy has good welding characteristics such that it is easy to attach the industrial tools to the second soft metal layer 20 by welding.

Next, the manufacturing method of the cutter 1 as an embodiment of the present invention illustrated in FIG. 1 will be described.

First, VC 20-90% by weight and pure titanium powder or titanium alloy powder 10-80% by weight, the titanium alloy powder containing titanium component 60% by weight or more, are aggregately mixed to form a first super hardness metal powder of a total amount of 100% by weight. The aggregate is then filled into a mold (not shown) to form a first super hardness metal layer.

Second, the pure titanium powder or titanium alloy powder 100% by weight which is the same material as that of the first super hardness metal layer is prepared and then filled as a layer onto the first super hardness metal layer filled in the mold, sequentially forming a second soft metal layer.

Third, the first super hardness metal layer and the second soft metal layer filled in the said mold is pressed and formed to obtain an integrally solidified molded product. The said product is pulled out of the said mold to be sintered in a vacuum furnace under a predetermined temperature (approximately 1,500 degrees Celsius).

The mold is not formed with a barrier between the first super hardness metal layer and the second soft metal layer, and two metal powders are not mutually mixed at a boundary region between the two metal layers. As a result, the sintered boundary region of the two integrally sintered layers is formed with a strong combining force because the titanium or titanium powder particles commonly used as constituting material for the first super hardness metal layer and the second soft metal layer are mutually sintered and bound.

Meanwhile, when the molded product is pressed and sintered, it is easy to form air holes inside the structure of the sintered body. The amount of air holes generating in the structure of the sintered body generally depends on pressure applied during the forming. Furthermore, air holes in the sintered body generally decrease the actual density of the sintered body, and if air holes exist at the edges of a tool part, the cutting capability of the tool part decreases.

In order to solve these drawbacks, metal particles of the two metal layers are respectively added with cobalt powder of 2-10% by weight.

When the cobalt powders added to mixed powders are pressed and sintered, the cobalt powders are easily liquefied under a high sintering temperature to obtain a high fluidity such that the liquefied cobalt flows into the air holes of the structure of the sintered body to fill the air holes. Once the air holes are filled, the density and hardness of the sintered body increases.

If the amount of cobalt is 2% by weight or less, this weight percentage does not suffice to fill the air holes in the sintered structure body. However, if the amount of the cobalt is 10% by weight or more, there occurs another problem in that the cobalt remaining after filling the air holes is unevenly distributed in the sintered structure body to give rise to segregation.

Finally, the second soft metal layer of the cutter 1 which is a finished powder-sintered multi-layer tool part is formed with mounting holes or screw holes 30 for coupling with an industrial tool, or a mounting part of the second soft metal layer is attached to an industrial tool by welding.

FIGS. 2 to 4 illustrate examples of various types of tool parts manufactured by the same method as that of the powder-sintered multi-layer tool part thus described.

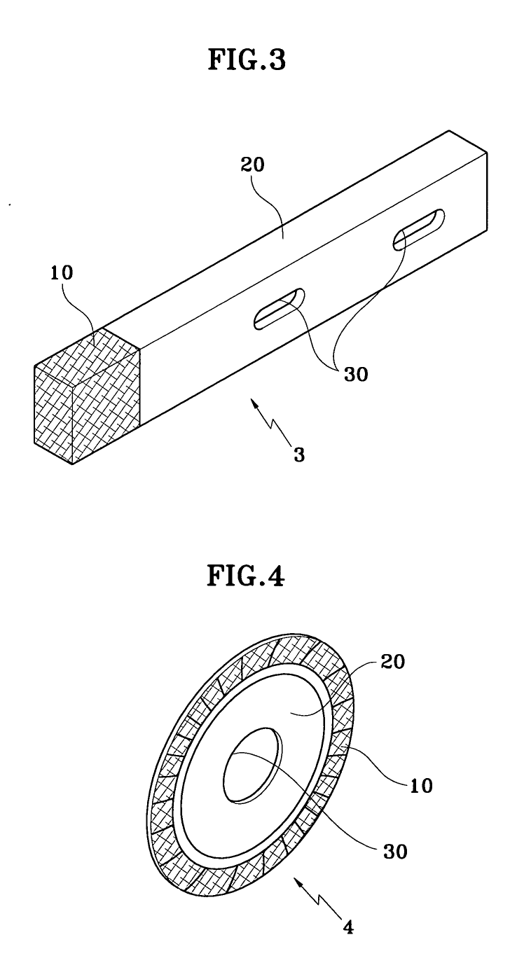

FIG. 2 illustrates a scissor blade 2 as a powder-sintered multi-layer tool part, FIG. 3 is a cam plate and FIG. 4 is a circular rotary knife 4. Like reference numerals are designated for like or equivalent parts or portions in FIGS. 1 to 4. The first super hardness metal layer 10 and the second soft metal layer 20 respectively illustrated in the embodiments of FIGS. 2 and 4 are manufactured by the same method and constitution as those of the embodiment of FIG. 1.

Although the cutter 1, the scissor blade 2, the cam plate 3 and the circular rotary knife 4 are illustratively described as examples of tool parts manufactured by the manufacturing method of powder-sintered multi-layer tool part, the present invention is by no means limited to the aforesaid embodiments, and those skilled in the art will recognize with various modifications within the scope and spirit of the appended claims.

As apparent from the foregoing, there is an advantage in the powder-sintered multi-layer tool part and a manufacturing method thereof thus described according to the present invention in that the abrasion resistance of the first super hardness metal layer and attachability of the second soft metal layer, the two tool parts being constituted in multi-layer form, can simultaneously and compatibly be satisfied.

There is another advantage in that titanium or titanium alloy particles commonly used for the first super hardness metal layer and the second soft metal layer are integrally and strongly bound during the forming and sintering process of tool parts, such that there occurs no separation between the tool parts constructed in multi-layer form, thereby enabling to manufacture a lighter tool part than the conventional steel-base metal tool part.

1. A powder-sintered multi-layer tool part comprising:
a first super hardness metal layer containing a vanadium carbide powder 20-90% by weight and a pure titanium powder or a titanium alloy powder 10-80% by weight, said titanium alloy powder containing a titanium component 60% by weight or more, thereby forming an aggregate mixed powder of 100% by weight and having a predetermined high hardness; and
a second soft metal layer having a mounting part and containing said pure titanium powder or said titanium alloy powder 100% by weight, wherein the metal powders of said first super hardness metal layer and said second soft metal layer are integrally pressed and sintered under a predetermined temperature.

2. The tool part as defined in claim 1 further comprising cobalt powder of 2-10% by weight respectively added to said first super hardness metal layer and said second soft metal layer.

3. The tool part as defined in claim 1 or 2, wherein said first super hardness metal layer has a hardness range of HRA 70 to HRA 95 by Rockwell Hardness Number, and said second soft metal layer has a hardness HRA 70 or less by Rockwell Hardness Number.

4. The tool part as defined in claim 1 or 2, wherein the predetermined temperature is 1,500 degrees Celsius or less.

5. The tool part as defined in claim 1 or 2, wherein said second soft metal layer is mounted to industrial tools by welding or screw coupling.

6. A manufacturing method of powder-sintered multi-layer tool part comprising the steps of:
forming a first super hardness metal layer containing a vanadium carbide powder 20-90% by weight and a pure titanium powder or a titanium alloy powder 10-80% by weight, said titanium alloy powder containing a titanium component 60% by weight or more, thereby forming an aggregate mixed powder of 100% by weight and having a predetermined high hardness:
powder-forming a second soft metal layer having a mounting part and containing said pure titanium powder or said titanium alloy powder 100% by weight; and
filling said metal powders of said first super hardness metal layer and said second soft metal layer in a mold for integral pressing and sintering said first super hardness metal layer and said second soft metal layer under a predetermined temperature.

7. The method as defined in claim 7 further comprising a step of adding cobalt powder of 2-10% by weight respectively to said first super hardness metal layer and said second soft metal layer.

8. The method as defined in claim 6 or 7, wherein said first super hardness metal layer has a hardness range of HRA 70 to HRA 95 by Rockwell Hardness Number, and said second soft metal layer has a hardness HRA 70 or less by Rockwell Hardness Number.

9. The tool part as defined in claim 6 or 7, wherein the predetermined temperature is 1,500 degrees Celsius or less.

10. The method as defined in claim 6 or 7, wherein said second soft metal layer is mounted to industrial tools by welding or screw coupling.
